(19) United States
(12) Patent Application Publication
(10) Pub. No.: US 2012/0091942 A1
(43) Pub. Date: Apr. 19, 2012

(54) SUBMERGED CHARGING STATION

(76) Inventors: Jack A. Jones, Los Angeles, CA (US); Yi Chao, Pasadena, CA (US); Thomas Curtin, Arlington, VA (US)

(21) Appl. No.: 13/004,857

(22) Filed: Jan. 11, 2011

Related U.S. Application Data
(60) Provisional application No. 61/393,078, filed on Oct. 14, 2010.

(51) Int. Cl. H01M 10/46

(52) U.S. Cl. 320/101

(57) ABSTRACT

A submerged charging station having a rechargeable energy producing device is disclosed. The device comprises a submerged thermally based electric generator that comprises a temperature-responsive material that utilizes differences in depths in order to generate energy. The submerged thermally based electric generator changes depths along a tether that is attached to a buoy and an anchor. The submerged thermally based electric generator provides energy to a battery, which can be part of the charging station, or to an autonomous underwater vehicle (AUV) that travels to different charging stations to be recharged.

### CROSS REFERENCE TO RELATED APPLICATIONS

This application claims priority to U.S. Provisional Application No. 61/393,078 filed on Oct. 14, 2010, which is incorporated herein by reference in its entirety.

### STATEMENT OF GOVERNMENT GRANT

The invention described herein was made in the performance of work under a NASA contract, and is subject to the provisions of Public Law 96-517 (35 USC §202) in which the Contractor has elected to retain title.

### FIELD

The present disclosure relates to charging stations. More particularly, the present disclosure relates to a submerged charging station comprising a buoy, and anchor, and a thermally based electric generator capable of charging a submerged thermally based rechargeable battery.

### BACKGROUND

There exists many thousands of battery powered ocean research buoys placed in oceans around the world. These research buoys perform scientific research on temperature, salinity, global warming, ocean currents, and pollution, among other activities. In addition, Autonomous Underwater Vehicles (AUVs) are becoming increasing important for science investigations, oil pipeline surveillance, DOD surveillance and mine detection. Unlike research buoys, AUVs can travel freely. Similar to research buoys, most AUVs are at present battery powered.

U.S. Pat. No. 5,291,847 discloses a submersible system that uses ocean temperature differences to supply buoyancy changes. This system uses a phase change material (PCM) that melts above 10° C. and freezes at temperatures below 10° C. The expansion upon melting causes a liquid to be compressed and stored, so that it can be released to an external bladder to create positive buoyancy when desired. Conversely, when the PCM freezes, it contracts and can accept fluid from the external bladder to cause the submersible to sink.

Jack A. Jones and Yi Chao, Novel Thermal Powered Technology for UUV Persistent Surveillance, Presentation to the ONR Joint Review of Unmanned Systems Technology Development, Panama City, Fla., Feb. 10, 2006, incorporated herein by reference in its entirety, shows an ocean thermal energy conversion (OTEC) system that uses hydraulic fluid from a phase change material (PCM) device, so that when the PCM compresses the liquid, it is stored in a high pressure bellows inside a pressurized nitrogen chamber. When electricity is desired, a valve is opened and the fluid pushes a piston that turns a generator to produce electricity.

In U.S. Pat. App. Pub. US2009/0013691, incorporated herein by reference in its entirety, a system is described in which a Phase Change Material (PCM) thermal power generator generates electricity based on differences in surrounding temperature. The generator contains PCM that is melted (expanded) at warm temperatures, for example 15 degrees C., and frozen (contracted) at cooler temperatures, for example 8 degrees C. Tubes containing the PCM, which can be paraffin such as pentadecane, are inserted into a container filled with hydraulic oil. When the PCM is melted (expanded), it pushes the oil out into a container that is pressurized to about 3000 psi. When a valve is opened, the high pressure oil passes through a hydraulic motor, which turns a generator and charges a battery. The low pressure oil is finally reabsorbed into the PCM canister when the PCM tubes are frozen (contracted). Some of the electricity produced could be used to control an external bladder or a motor to the tether line, such that depth cycling is continued for a very long period of time.

A variation of the PCM thermal power generator uses low pressure oil exiting from a hydraulic motor to be vented directly to an external bladder, such that filling of the bladder causes the generator to rise, and emptying of the bladder allows the generator to descend. This is much more energy efficient in that the inefficiencies of converting thermal energy to electrical energy to mechanical energy is avoided.

Both the research buoys and AUVs known in the art are battery powered. However, the batteries are not rechargeable. The research buoys are disposable after the batteries wear out, which is typically after some months of use or a couple hundred ascent/descent cycles. The battery-powered, horizontal-motion AUVs have limited lifetimes of a few days to a few weeks, which greatly limits the distance in which AUVs can travel underwater.

### SUMMARY

The disclosure described herein circumvents these problems by providing a charging station comprising a battery. The charging station uses temperature differences at various depths in the ocean to produce electricity, which is then stored in a submerged battery. According to several embodiments of the present disclosure, the submerged rechargeable battery can allow a buoy with scientific instrumentation to function indefinitely without being limited by ascent/descent cycles. Similarly, the charging station described herein can allow AUVs to recharge their batteries before continuing on to the next charging station, thus allowing the AUV to travel great distances in a relatively short period of time.

According to a first aspect, a charging station is provided, wherein the charging station comprises a partially or fully submerged buoy attached to a tether that is attached to an anchor, a submerged thermally based electric generator attached to the tether, and a submerged rechargeable battery capable of being charged by the submerged thermally based electric generator attached to the tether.

According to a second aspect, a system is provided, wherein the system comprises a plurality of submerged charging stations as described by the first aspect.

According to a third aspect, a charging station is provided, wherein the charging station comprises a partially or fully submerged buoy attached to a tether that is attached to an anchor, and a submerged thermally based electric generator capable of charging a rechargeable battery that is part of an autonomous underwater vehicle.

According to a fourth aspect, a system is provided, wherein the system comprises a plurality of submerged charging stations as described by the third aspect.

Further aspects of the disclosure are provided in the specification, drawings, and claims of the present application.

### BRIEF DESCRIPTION OF THE DRAWINGS

The accompanying drawings, which are incorporated into and constitute a part of this specification, illustrate one or more embodiments of the present disclosure and, together with the detailed description and the examples, serve to explain the principles and implementations of the disclosure.

FIG. 1 shows a submerged charging station.

FIG. 2 shows an electric generator adapted to be used with the submerged charging station.

FIG. 3 shows another electric generator adapted to be used with the submerged charging station where both electricity and buoyancy control are produced.

FIG. 4 shows an example of a heat-transfer based electric generator adapted as a submersible vehicle to be used with the present disclosure. FIG. 4A is a top view, FIG. 4B is a side view.

FIG. 5 shows an example of how CO₂ can be used as the PCM with the present disclosure.

FIG. 6 shows a graph of locations of disposable, non-rechargeable battery-powered buoys.

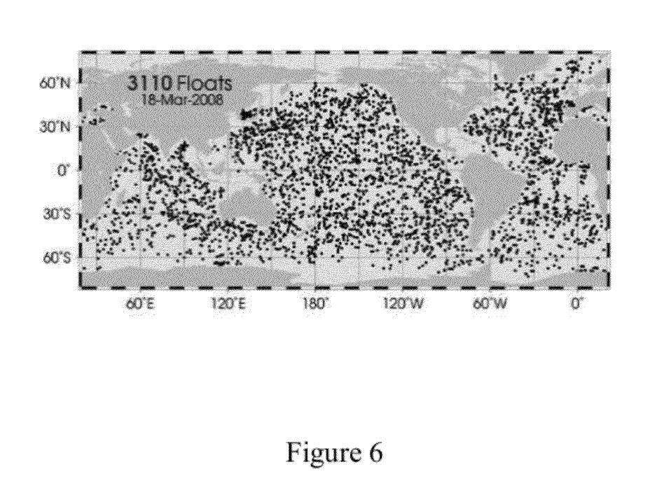

### DETAILED DESCRIPTION

The present disclosure is directed to a charging station. The charging station exploits thermal gradients for recharging the batteries and has few or no floating or visible parts. It is thus resistant to storms, inadvertent ocean vessel collisions, or enemy sabotage. The charging station can be used in oceans, lakes, rivers, or any other large body of water or liquid having varying temperatures.

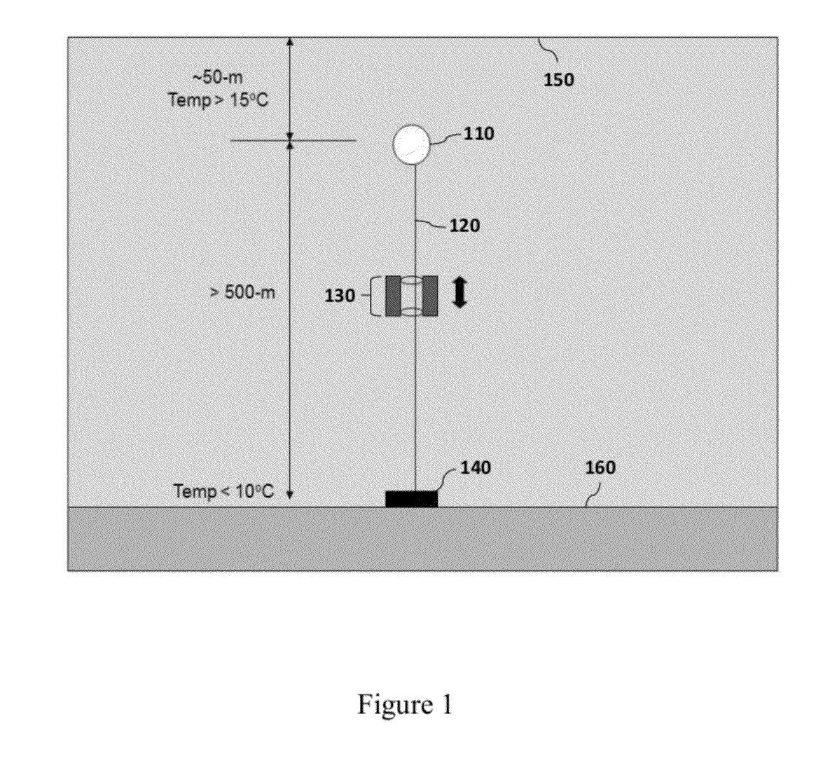

FIG. 1 is illustrative in showing the submerged charging station described herein. A submerged buoy (110) rests at a depth of approximately 50 m below a water surface (150). The submerged buoy (110) is attached to a tether (120) that is further attached to an anchor and battery (140) at a bottom of an ocean or lake (160). By way of example, the bottom is greater than 500 m deeper than the submerged buoy and the water temperature is greater than 15° C. at the buoy and less than 10° C. near the anchor. A submersible vehicle (130) adapted to descend or ascend to different depths along the tether contains a cycling thermal Phase Change Material (PCM) electric generator (not shown) that charges the submerged rechargeable battery. The PCM electric generator generates electricity as a result of materials within the PCM electric generator that condense or expand as a result from differences in water temperature at different depths. Some embodiments use pentadecane as the PCM. Thermally based electric generators that utilize PCM are described in greater detail in U.S. Pat. No. 5,291,847, and U.S. Pat. App. Pub. US2009/0013691, both of which are incorporated herein by reference.

As described herein, a buoy is an object that is anchored. The buoy can be partially submerged at the surface of a body of water, such as a lake or an ocean, or can be completely submerged, for example, tens, hundreds or even thousands of feet below the surface. It is preferred to have the upper buoy submerged a reasonable distance below the surface, so as not to be seen from above and not to be inadvertently destroyed by storms or ocean going vessels.

As described herein, an electric generator is a device that generators electric power.

The anchor (140) can be any object that allows positioning of the buoy as understood by one skilled in the art. The buoy (110) has an overall density that is lower than water, so that it floats. A tether can be made of or include, but is not limited to, any type of cable or rope. The tether can further be adapted to be used as a means to transfer electricity.

In some embodiments, the buoy and/or tether are resistant to biofouling. Biofouling is the undesirable accumulation of microorganisms, plants, algae, and/or animals on wetted structures, and can be minimized by special coatings as is well known to one skilled in the art. In some embodiments, the rechargeable battery is located close to or in the buoy. In some embodiments, the rechargeable battery is located in the anchor.

In some embodiments, the rechargeable battery is located in the buoy. In some other embodiments, the rechargeable battery is located in the anchor. In some additional embodiments, the battery is located in a submersible vehicle. The purpose of the battery is not intended to be limited to any particular use. The battery can be used, for example, to charge instrumentation on the charging system. The battery can also be part of an autonomous vehicle that is not part of the charging system, yet provides a means for the autonomous vehicle to dock to the charging station to provide power to the battery of the autonomous vehicle. The battery can also be used to generate power to a submersible vehicle that is part of the charging station in order to allow the submersible vehicle to ascend or descend. The battery can also be used to conduct underwater science measurements or to power sonar communications relays. The battery should not be construed to be limited to any particular type of battery. For example, the battery may include, but should not be limited to, lead-acid, nickel cadmium (NiCd), nickel metal hydride (NiMH), lithium ion (Li-ion), and lithium ion polymer (Li-ion polymer).

The battery can be charged by inductive transfer through a magnet that doesn't require direct electrical contact. However, transfer of electricity from a generator to a battery can occur in any manner known in the art, by way of example, by direct electrical transfer or microwave energy transfer.

A submersible vehicle as described herein is any containment system that aids a submerged thermally based electric generator to ascend or descend to varying depths in order to be exposed to different temperatures. One skilled in the art could envision a multitude of means in which the submersible vehicle can aid in the ascent or descent of a thermally based electric generator. The submersible vehicle can be a containment mechanism within which the generator is contained along with canisters holding phase change material. The submersible vehicle can also be a containment mechanism in which a battery is further contained along with the generator and canisters holding phase change material. In some embodiments, the submersible vehicle can ascend or descend as a result of a motor. One skilled in the art would further recognize that such a motor could either be part of the submersible vehicle, or by other means known in the art, such as being contained within the anchor, for example. One skilled in the art would further recognize that a motor can be attached to a pulley mechanism, such as a rope, that can be adapted to aid in the ascent and/or descent to the thermally based electric generator. One skilled in the art would recognize however, that the submersible vehicle can ascend or descend by any other mechanism allowing the submersible vehicle to do so, for example, using an electric pump to change the volume of an external bladder, or by any other mechanism that allows the submersible vehicle to ascend or descend along the tether, whether autonomously, or with the aid of an external mechanism, e.g. a motor and/or pulley.

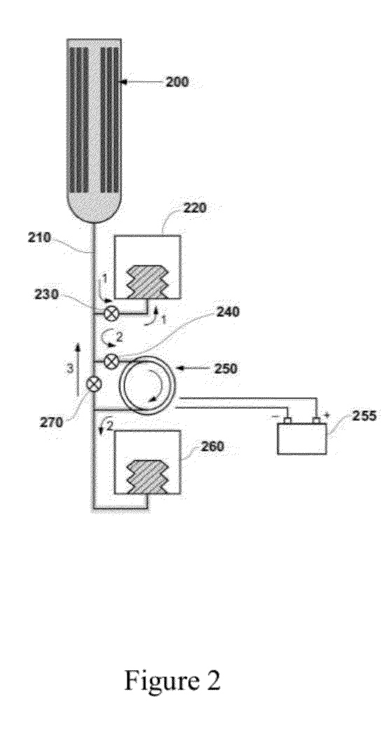

Thermally based electric generators that use PCM are illustrated in FIG. 2, which is taken from U.S. Pat. App. Pub. US2009/0013691. Phase Change Material (PCM) melting in a PCM vessel (200) causes hydraulic fluid (210) to be stored in gas spring bellows (220) (e.g., at a pressure of 3000 psia) when the hydraulic fluid is flowed past valve (230) (path 1). When power is desired, valve (240) is opened and the fluid passes through a hydraulic motor (250) (path 2), which allows charging of a battery (255). After the fluid leaves the hydraulic motor, it is stored in a low pressure (e.g., 20 psia) spring bellows device (260) (see also path 2), and is ultimately returned to the PCM vessel when valve (270) is opened (path 3).

Approximately 6100 Joules of electricity is produced during each dive cycle of SOLO-TREC AUV. However, one skilled in the art would recognize that the embodiments described herein are not limited to the SOLO-TREC, and that any suitable PCM-based charging station can be used to generate much greater or much less amounts of electricity as desired. A dive cycle is one cycle of ascent followed subsequently by a descent, or one cycle of descent followed subsequently by an ascent.

PCM vessels allow PCM material to melt at higher temperatures, which causes hydraulic fluid to be stored in gas spring bellows. When power is desired, a valve can be opened to allow fluid to pass through a hydraulic motor, which allows charging of a battery. After the fluid leaves the hydraulic motor, it is stored in a low pressure spring bellows device and ultimately returned to the PCM vessel. In some embodiments, the thermally based electric generator produces both electricity and buoyancy control if the lower pressure fluid is vented to an external bladder at depth.

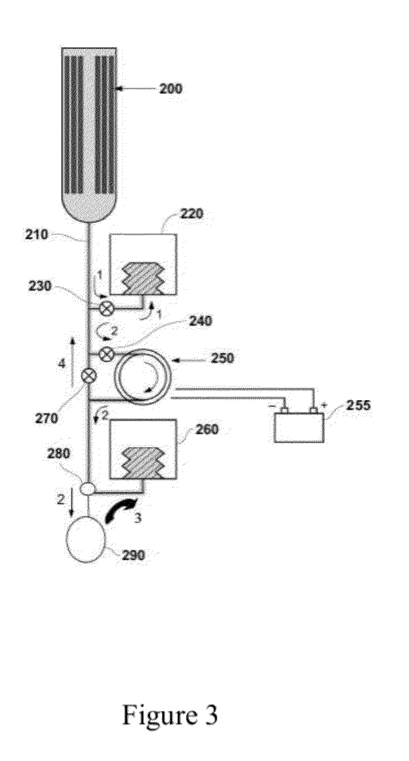

Variations of thermally based electric generators that use PCM where both electricity and buoyancy control are produced if the lower pressure fluid is vented to an external bladder at depth are further illustrated in FIG. 3, which is taken from U.S. Pat. App. Pub. US2009/0013691, incorporated herein by reference in its entirety. When PCM fluid (210) leaves the hydraulic motor (250) (path 2), it is allowed to pass through valve (280) into a low pressure spring bellows device (260). Some fluid is further directed into an external expandable chamber or bladder (290) on the charging station, thus causing the charging station to rise.

In some embodiments, pentadecane is used as the PCM. Pentadecane is useful because the phase changes within temperature differences of 10° C. In other embodiments, other paraffins such as hexadecane, which has phase changes within temperature differences of 18° C. can be used. Some embodiments use a combination of PCM materials. Other paraffin PCMs or non-paraffin PCMs, such as alcohols or oils, can be used as is known in the art.

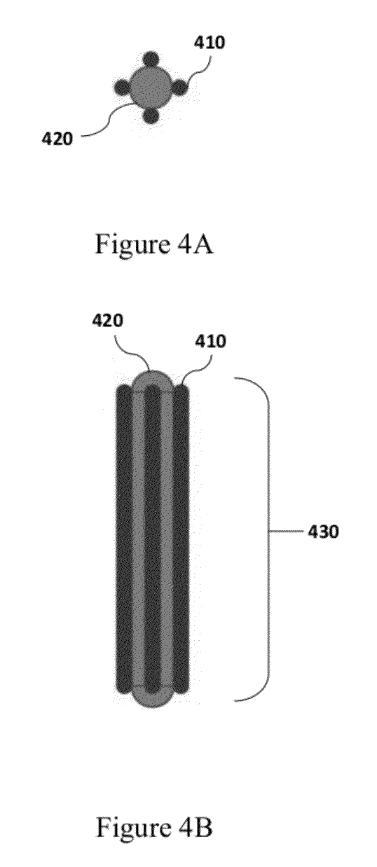

FIG. 4 provides an example of one way in which a heat-transfer electric generator can be realized, although one skilled in the art would appreciate a variety of mechanisms to utilize PCM materials. PCM is provided in canisters (410) that are part of the PCM vessel (430) that can be used to allow a submerged thermally based electric generator (not shown) to vary its depth to various temperatures in order to generate electricity. Canisters (410) of phase change material (PCM) that expand when melted in warm ocean temperatures near the surface can be used. The canisters are attached to the sides of a central container (420) of the hydraulic motor generator system that can be partially filled with low density hollow glass beads to act as buoyancy for the four heavier PCM canisters. The expansion of the canisters squeezes internal tubes filled with oil, thus pressurizing the oil to, e.g., 3000 psi. The oil is then stored in an internal pressurized vessel. At a later time, the oil is allowed to flow through a hydraulic generator, thus generating electricity. The low pressure oil is stored separately and allowed to reenter the original PCM oil tubes when the PCM freezes at lower, colder ocean temperatures.

One skilled in the art would recognize that each canister may be of a variety of sizes and shapes. One example could provide canisters that are 20 cm in diameter×2.5 m long with a central buoyancy container that is 50 cm in diameter×2.5 m long. The canister can further be filled with 6% aluminum foam to enhance thermal conductivity and therefore reduce the heat transfer time constant. With such dimensions, approximately 150 kg of pentadecane could be used.

In some embodiments, the charging station includes an electric generator driven by working fluid subjected to a thermodynamic cycle. One such fluid could be, for example, CO₂ because it has the requisite physical properties for use in the range of temperatures expected to be encountered in operation, is not flammable, and is much less toxic than are many other commercially available refrigerant fluids. The system can be housed in a pressurized central compartment equipped with a double hull. One skilled in the art would recognize that other gases, including but not limited to, ethane, Freon 13, or ethylene, could be used.

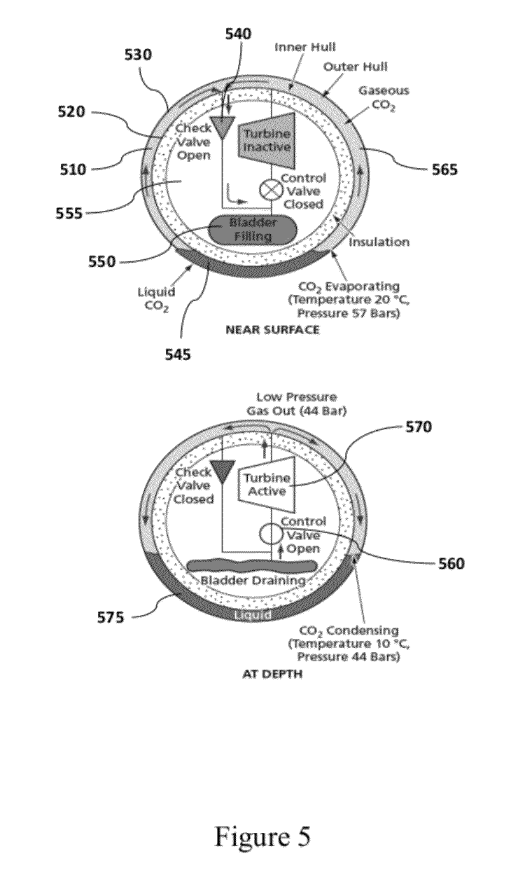

FIG. 5 provides an example of the use of a thermally based electric generator that utilizes CO₂ to drive a turbine engine in an autonomous underwater vehicle. A thermodynamic cycle would begin when the submersible vehicle (as described in FIG. 1) is at maximum depth, where CO₂ would condense and be stored (545), at relatively low temperature and pressure, in an annular volume (510) between inner (520) and outer (530) hulls. The cycle resumes once the submersible vehicle ascends to near the surface, where the ocean temperature is typically ≧20° C. At this temperature, the CO₂ previously stored at depth in the annular volume between the inner and outer hulls would be pressurized to ≈57 bar (5.7 MPa). The pressurized gaseous CO₂ (565) would flow through a check valve (540) into a bladder (550) inside a pressurized compartment (555), thereby storing energy of relatively warm, pressurized CO₂ for subsequent use after a next descent to maximum depth. Upon descent, the outer hull would become cooled—possibly to a minimum temperature as low as about 4° C. at a depth of about 1000 m. Cooling to 10° C. or less would reduce the pressure of CO₂ (575) remaining in the annular volume to about 44 bars (4.4 MPa) or less. A control valve (560) would then be opened, allowing CO₂ from the pressurized bladder to expand through a turbine (570), thus producing electricity for recharging a battery (not shown). After flowing through the turbine and the control valve, the CO₂ would reenter the annular volume (510), where it would be condensed at low temperature and pressure, completing the thermodynamic cycle.

One skilled in the art would recognize that other heat or thermally based electric generators can be based on methods that produce high pressure liquid or gas that can be used to generate electricity.

In some embodiments, the charging station charges a rechargeable battery that is part of an autonomous underwater vehicle (AUV). An AUV can include, but is not limited to, gliding submersibles for the Navy and other research purposes.

In some embodiments, a plurality of charging stations can be provided. The charging stations can be positioned at locations so that an AUV can travel between the individual systems in order to allow the AUV to be recharged. The plurality of charging stations can include stations having detector instruments that are placed in positions allowing differential detection of respective conditions.

In some embodiments, the charging system can comprise one or more communication instruments. The communication instruments can be attached to the buoy, the tether, the anchor, the submerged thermally based electric generator, the submerged rechargeable battery, the submersible vehicle, or a combination of any of the above. A communication instrument can include, but is not limited to, satellite or radio transmission with an antenna that is always or intermittently on the ocean surface, or to provide acoustic (sonar) communication relays when underwater.

In some embodiments, the charging system can comprise one or more detector instruments. The detector instruments can be attached to the buoy, the tether, the anchor, the submerged thermally based electric generator, the submerged rechargeable battery, the submersible vehicle, or a combination of any of the above. A detector instrument can include, but it not limited to, instruments adapted to detect ocean climate change, pollution, salinity, or currents.

Although any methods and materials similar or equivalent to those described herein can be used in the practice for testing of the products, methods and system of the present disclosure, exemplary appropriate materials and methods are described herein as examples.

What has been described is a charging station comprising a rechargeable battery. While this charging station has been described by means of specific embodiments and applications thereof, modifications of the above-described modes for carrying out the disclosure that are obvious to persons of skill in the art are intended to be within the scope of the following claims. All patents and publications mentioned in the specification are indicative of the levels of skill of those skilled in the art to which the disclosure pertains.

It is to be understood that the disclosures are not limited to particular charging stations or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The entire disclosure of each document cited (including patents, patent applications, journal articles, abstracts, laboratory manuals, books, or other disclosures) in the Background, Summary, and Detailed Description is hereby incorporated herein by reference. All references cited in this disclosure are incorporated by reference to the same extent as if each reference had been incorporated by reference in its entirety individually.

What is claimed is:

1. A charging station comprising
a partially or fully submerged buoy attached to a tether that is attached to an anchor,
a submerged thermally based electric generator attached to the tether, and
a submerged rechargeable battery capable of being charged by the submerged thermally based electric generator attached to the tether.

2. The charging station of claim 1, wherein the submerged thermally based electric generator uses Phase Change Material (PCM) to produce electricity.

3. The charging station of claim 2, wherein the PCM is pentadecane and/or hexadecane.

4. The charging station of claim 1, wherein the submerged thermally based electric generator uses CO₂ to produce energy.

5. The charging station of claim 1, wherein the rechargeable battery is located in the buoy.

6. The charging station of claim 1, wherein the rechargeable battery is located at the bottom of the dive cycle and/or near the anchor.

7. The charging station of claim 1, wherein the tether and/or the buoy are resistant to biofouling.

8. The charging station of claim 1, wherein the submerged thermally based electric generator is part of a submersible vehicle adapted to descend or ascend to different depths along the tether.

9. The charging station of claim 8, wherein the rechargeable battery is part of the submersible vehicle.

10. The charging station of claim 8, wherein the vehicle further comprises an external bladder that allows the submersible vehicle to ascend or descend.

11. The charging station of claim 8, wherein the submersible vehicle is connected to a motor that allows the submersible vehicle to ascend or descend.

12. The charging station of claim 8, further comprising one or more communication instruments attached to one or more of the buoy, the tether, the anchor, the submerged thermally based electric generator, the submerged rechargeable battery, or the submersible vehicle.

13. The charging station of claim 12, wherein the one or more communication instruments comprise sonar.

14. The charging station of claim 12, wherein the one or more communication instruments comprise a satellite communication system.

15. The charging station of claim 12, further comprising one or more detector instruments attached to one or more of the buoy, the tether, the anchor, the submerged thermally based electric generator, the submerged rechargeable battery, or the submersible vehicle.

16. The charging station of claim 15, wherein the one or more detector instruments are adapted to detect ocean climate change, pollution, salinity, or currents.

17. The charging station of claim 1, wherein the charging station is positioned in a lake or ocean.

18. A system comprising a plurality of charging stations according to claim 1.

19. A charging station comprising
a partially or fully submerged buoy attached to a tether that is attached to an anchor, and
a submerged thermally based electric generator capable of charging a rechargeable battery that is part of an autonomous underwater vehicle.

20. A system comprising a plurality of submerged charging stations according to claim 19.

21. A charging station comprising
a partially floating buoy attached to a tether,
a submerged thermally based electric generator attached to the tether, and
a submerged rechargeable battery capable of being charged by the submerged thermally based electric generator attached to the tether.

22. The charging station of claim 21, wherein the submerged thermally based electric generator is part of a submersible vehicle adapted to descend or ascend to different depths along the tether.
